(19) United States
(12) Patent Application Publication
(10) Pub. No.: US 2026/0244007 A1
(43) Pub. Date: Aug. 20, 2026

(54) Anti-Counterfeiting Element

(71) Applicants: ZHONGCHAO SPECIAL SECURITY TECHNOLOGY CO., LTD, Beijing (CN); CHINA BANKNOTE PRINTING AND MINTING CORP., Beijing (CN)

(72) Inventors: Haibo Cui, Beijing (CN); Baoli Zhang, Beijing (CN); Xinyi Li, Beijing (CN)

(21) Appl. No.: 18/843,011

(22) PCT Filed: Feb. 1, 2024
(86) PCT No.: PCT/CN2024/075104

§ 371 Date: Aug. 30, 2024

(30) Foreign Application Priority Data
Apr. 24, 2023 (CN) 202310449055.X

(51) Int. Cl. G02B 17/06; B42D 25/324; G02B 17/00

(52) U.S. Cl. CPC G02B 17/0647; B42D 25/324; G02B 17/002

(57) ABSTRACT

Disclosed is an anti-counterfeiting element. The anti-counterfeiting element includes: a substrate; a reflecting curved mirror, at least part of the plurality of reflecting curved mirrors are provided with an independent micro graphic-text structure, the micro graphic-text structure is divided into a plurality of micro graphic-text areas from a central position to an edge position of the substrate, a duty ratio of a micro graphic-text area at the central position is larger than a duty ratio of a micro graphic-text area at the edge position; the reflecting curved mirror displays as a three-dimensional pattern with depth of field after sampling and synthesizing with the micro graphic-text structure having a coupling effect with it; and a minimum unit radian of each reflecting curved mirror having the micro graphic-text structure corresponds to a projection angle, so that only a side surface of the three-dimensional pattern is able to be seen at an angle.

### CROSS-REFERENCE TO RELATED APPLICATION

The disclosure claims the priority to the Chinese Patent Application No. 202310449055.X filed to the China National Intellectual Property Administration (CNIPA) on Apr. 24, 2023 and entitled “anti-counterfeiting element”, which is hereby incorporated by reference in its entirety.

### TECHNICAL FIELD

The disclosure relates to the technical field of optical anti-counterfeiting, and in particular to an anti-counterfeiting element.

### BACKGROUND

Due to unique visual effect and easy identification, an anti-counterfeiting element is widely applied to high security products such as bank notes, credit cards, passports and securities and other high value-added products.

In the related art, CN200480040733 and CN200680026431 disclose an anti-counterfeiting element with a microlens array and a micro graphic-text array on both surfaces of a substrate, respectively, the micro graphic-text array is located near the focal plane of the microlens array, and a pattern with a certain depth of field or exhibiting dynamic effects is reproduced by moire magnification of the microlens array on the micro graphic-text array. CN111615648A discloses that the micro graphic-text array and the microlens array are located on the same side of the substrate, the structural design effectively avoids the alignment problem of the microlens technology in the engineering process, and the strict alignment requirement of the microlens array and the micro graphic-text array may be achieved.

The above patents in the related art effectively solves the alignment problem of the microlens in the engineering production process, but the comprehensive design of the microlens and the micro graphic-text is not clearly developed, and only the effect with certain depth of field, namely floating or sinking, is expressed; or a three-dimensional pattern with a certain viewing angle effect. The depth of field effect is not combined with the strict alignment advantage of a reflecting curved mirror to form an optical effect with continuous change of depth of field which shocks human eyes.

That is to say, the anti-counterfeiting element in the related art has the problem of poor observation effect of human eyes.

### SUMMARY

A main objective of the disclosure is to provide an anti-counterfeiting element, for solving the problem that the anti-counterfeiting element in the related art has a poor observation effect of human eyes.

In order to achieve the above objective, some embodiments of the disclosure provide an anti-counterfeiting element, including: a substrate; a reflecting curved mirror, a plurality of reflecting curved mirrors are arranged on a side surface of the substrate in an array; a micro graphic-text structure, at least part of the plurality of reflecting curved mirrors is provided with the independent micro graphic-text structure, the micro graphic-text structure is divided into a plurality of micro graphic-text areas from a central position to an edge position of the substrate, using a period of the reflecting curved mirror as a unit, and a duty ratio of a micro graphic-text area at the central position of the substrate is larger than a duty ratio of a micro graphic-text area at the edge position of the substrate; the reflecting curved mirror displays as a three-dimensional pattern with depth of field after sampling and synthesizing with the micro graphic-text structure having a coupling effect with it, and the three-dimensional pattern at least partially suspends on a side, away from the substrate, of the reflecting curved mirror; and a minimum unit radian of each reflecting curved mirror having the micro graphic-text structure corresponds to a projection angle, so that only a side surface of the three-dimensional pattern is able to be seen at an angle on the side, away from the substrate, of the reflecting curved mirror.

In some embodiments, the micro graphic-text structure is arranged in a periodic array to be displayed as three-dimensional patterns with different depths of field; or the micro graphic-text structure is arranged in a nonperiodic array to be displayed as three-dimensional patterns with continuous depth of field.

In some embodiments, duty ratios of the plurality of micro graphic-text areas are gradually decreased from the central position to the edge position of the substrate.

In some embodiments, the micro graphic-text structure is a micro graphic-text groove, and at least part of the micro graphic-text groove in each reflecting curved mirror penetrates through a top surface and a bottom surface of the reflecting curved mirror.

In some embodiments, densities of micro graphic-text grooves on the plurality of reflecting curved mirrors are gradually decreased from the central position to the edge position of the substrate.

In some embodiments, when a duty ratio of a micro graphic-text area is a maximum value, a projection area of the three-dimensional pattern displayed by the micro graphic-text area on the substrate is a minimum, and the three-dimensional pattern is vertically displayed on the side, away from the substrate, of the reflecting curved mirror.

In some embodiments, a side view of the three-dimensional pattern vertically arranged is able to be seen when observed from part of angles of a side, having the reflecting curved mirror, of the substrate.

In some embodiments, the plurality of micro graphic-text areas include a first micro graphic-text area, a second micro graphic-text area and a third micro graphic-text area in sequence from the central position to the edge position of the substrate, and a duty ratio is gradually decreased from the first micro graphic-text area to the third micro graphic-text area.

In some embodiments, the first micro graphic-text area at least includes a group of reflecting curved mirrors having the micro graphic-text structure, and the first micro graphic-text area presents a side view when the three-dimensional pattern is vertical under a corresponding angle.

In some embodiments, the second micro graphic-text area at least includes two groups of reflecting curved mirrors having the micro graphic-text structure, duty ratios of the two groups of reflecting curved mirrors having the micro graphic-text structure are the same, and the two groups of reflecting curved mirrors having the micro graphic-text structure are arranged in a manner of clamping the first micro graphic-text area, and a projection area of the three-dimensional pattern displayed by the second micro graphic-text area on the substrate is greater than a projection area of the three-dimensional pattern displayed by the first micro graphic-text area on the substrate.

In some embodiments, the third micro graphic-text area at least includes two groups of reflecting curved mirrors having the micro graphic-text structure, and duty ratios of the two groups of reflecting curved mirrors having the micro graphic-text structure are the same.

In some embodiments, the plurality of reflecting curved mirrors are all convex mirrors or concave mirrors.

In some embodiments, at least part of the plurality of reflecting curved mirrors is arranged in a periodic array.

In some embodiments, the anti-counterfeiting element further includes a reflecting layer, which is arranged on a side surface, away from the substrate, of the reflecting curved mirror.

In some embodiments, the reflecting layer includes one or more of the following: a single-layer metal coating, a multi-layer metal coating, a coating formed by an absorption layer, a low-refractive-index dielectric layer and a reflective film layer, a high-refractive-index dielectric layer coating, a multi-dielectric-layer coating formed by a first high-refractive-index dielectric layer, the low-refractive-index dielectric layer and a second high-refractive-index dielectric layer stacked in sequence, and a coating formed by the absorption layer, a high-refractive-index dielectric layer and the reflective film layer stacked in sequence.

In some embodiments, the anti-counterfeiting element further includes a microstructure, the microstructure is arranged in the micro graphic-text groove, and the microstructure includes one of a one-dimensional submicron structure, a two-dimensional submicron structure and an interference structural color.

In some embodiments, the anti-counterfeiting element further includes a first color functional layer and a second color functional layer, the first color functional layer is arranged in the micro graphic-text groove, the second color functional layer is arranged on a surface of the reflecting curved mirror, and the first color functional layer includes one of a single-layer coating, a multi-layer coating, an ink, a pigment and a dye; and/or the second color functional layer includes one of the single-layer coating, the multi-layer coating, the ink, the pigment and the dye.

By adoption of the technical solution of the disclosure, the anti-counterfeiting element includes the substrate, the reflecting curved mirror and the micro graphic-text structure, and the plurality of reflecting curved mirrors are arranged on the side surface of the substrate in an array; at least part of the reflecting curved mirrors is provided with the independent micro graphic-text structures, the micro graphic-text structure is divided into the plurality of micro graphic-text areas from the central position to the edge position of the substrate, using the period of the reflecting curved mirror as a unit, and the duty ratio of the micro graphic-text area at the central position of the substrate is greater than that of the micro graphic-text area at the edge position of the substrate; the reflecting curved mirror displays as a three-dimensional pattern with depth of field after sampling and synthesizing with the micro graphic-text structure having the coupling effect with it, and the three-dimensional pattern at least partially suspends on the side, away from the substrate, of the reflecting curved mirror; and a minimum unit radian of each reflecting curved mirror having the micro graphic-text structure corresponds to the projection angle, so that only the side surface of the three-dimensional pattern is able to be seen at the angle on the side, away from the substrate, of the reflecting curved mirror.

The reflecting curved mirror and the micro graphic-text structure are arranged on the same side of the substrate, so that the reflecting curved mirror and the micro graphic-text structure of the disclosure are able to ensure that an optical effect has continuous depth of field without alignment, which is beneficial for ensuring a display effect. The micro graphic-text structure on the at least part of the plurality of reflecting curved mirrors is independently arranged, that is, the at least part of the plurality of reflecting curved mirrors has a complete micro graphic-text structure, so that the reflecting curved mirror having the independent and complete micro graphic-text structure is able to display a complete pattern with depth of field. Due to that the duty ratio of the micro graphic-text area at the central position of the substrate is larger than that of the micro graphic-text area at the edge position of the substrate, so that the reflecting curved mirror displays as the three-dimensional pattern with depth of field after sampling and synthesizing with the micro graphic-text structure having the coupling effect with it, and the three-dimensional pattern at least partially suspends on the side, away from the substrate, of the reflecting curved mirror, so that an optical effect with change of depth of field which shocks human eyes is achieved; and the minimum unit radian of each reflecting curved mirror having the micro graphic-text structure corresponds to the projection angle, so that only the side surface of the three-dimensional pattern is able to be seen at the angle on the side, away from the substrate, of the reflecting curved mirror. The anti-counterfeiting element of the disclosure combines an advantage that the reflecting curved mirror and the micro graphic-text structure are arranged on the same side of the substrate, the unique duty ratio of the micro graphic-text structure is designed, the three-dimensional pattern with depth of field is formed, and a recognition difficulty of human eyes is decreased.

### BRIEF DESCRIPTION OF THE DRAWINGS

The drawings forming a part of the disclosure in the specification are adopted to provide a further understanding to the disclosure. Specific embodiments of the disclosure and descriptions thereof are adopted to explain the disclosure and not intended to form improper limits to the disclosure. In the drawings:

FIG. 1 shows a display schematic diagram of an anti-counterfeiting element according to an embodiment of the disclosure.

FIG. 2 shows a structural schematic diagram of an anti-counterfeiting element in FIG. 1.

FIG. 3 shows a top view of an anti-counterfeiting element in FIG. 1.

FIG. 4 shows a design diagram of different micro graphic-text areas of an anti-counterfeiting element according to an embodiment of the disclosure.

FIG. 5 shows a schematic diagram of multiple frames of images generated by designing a three-dimensional pattern displayed by an anti-counterfeiting element of the disclosure by adopting an original image of a three-dimensional object.

FIG. 6 shows a schematic diagram of multiple of frames of images generated by designing a three-dimensional pattern displayed by an anti-counterfeiting element of the disclosure by adopting a projection image of a three-dimensional object.

The drawings include the following reference signs.

10. Anti-counterfeiting element; 11. Substrate; 12. Reflecting curved mirror; 13. Micro graphic-text structure; 14. Reflecting layer; 15. First micro graphic-text area; 16. Second micro graphic-text area; 17. Third micro graphic-text area; and 20. Human eyes.

### DETAILED DESCRIPTION OF THE EMBODIMENTS

It is to be noted that the embodiments and features in the embodiments of the disclosure may be combined with each other without conflict. The disclosure will be described in detail below with reference to the accompanying drawings and the embodiments.

It is to be noted that, unless defined otherwise, all technical and scientific terms used herein have the same meaning as commonly understood by those of ordinary skill in the art to which the disclosure belongs.

In the disclosure, unless stated to the contrary, the orientation term such as “upper, lower, top, bottom” or the like, generally refers to the direction shown in the drawings, or to the vertical, perpendicular, or gravitational direction of components; likewise, for ease of understanding and description, “inner and outer” refer to inner and outer relative to the profile of the components, but the above orientation terms are not intended to limit the disclosure.

The disclosure provides an anti-counterfeiting element, for solving the problem that the anti-counterfeiting element in the related art has a poor observation effect of human eyes.

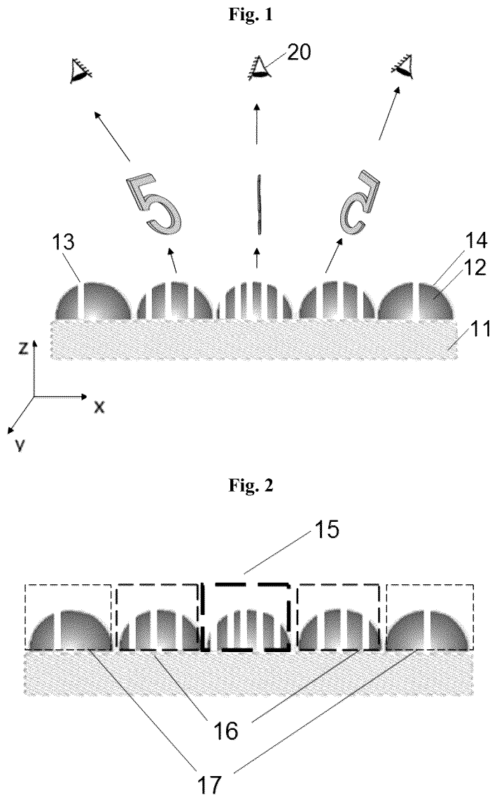

As shown in FIGS. 1-6, the anti-counterfeiting element 10 includes a substrate 11, a reflecting curved mirror 12 and a micro graphic-text structure 13, a plurality of reflecting curved mirrors 12 are provided, and the plurality of reflecting curved mirrors 12 are arranged on a side surface of the substrate 11 in an array; at least part of the plurality of reflecting curved mirrors 12 is provided with the independent micro graphic-text structure 13, the micro graphic-text structure 13 is divided into a plurality of micro graphic-text areas from a central position to an edge position of the substrate 11, using a period of the reflecting curved mirror 12 as a unit, and a duty ratio of a micro graphic-text area at the central position of the substrate 11 is greater than a duty ratio of a micro graphic-text area at the edge position of the substrate 11; the reflecting curved mirror 12 displays as a three-dimensional pattern with depth of field after sampling and synthesizing with the micro graphic-text structure 13 having a coupling effect with it, and the three-dimensional pattern at least partially suspends on a side, away from the substrate 11, of the reflecting curved mirror 12; and a minimum unit radian of each reflecting curved mirror 12 having the micro graphic-text structure 13 corresponds to a projection angle, so that only a side surface of the three-dimensional pattern is able to be seen at an angle on the side, away from the substrate 11, of the reflecting curved mirror 12.

The reflecting curved mirror 12 and the micro graphic-text structure 13 are arranged on the same side of the substrate 11, so that the reflecting curved mirror 12 and the micro graphic-text structure 13 of the disclosure are able to ensure that an optical effect has continuous depth of field without alignment, which is beneficial for ensuring a display effect. The micro graphic-text structure 13 on the at least part of the plurality of reflecting curved mirrors 12 is independently arranged, that is, the at least part of the plurality of reflecting curved mirrors 12 has a complete micro graphic-text structure 13, so that the reflecting curved mirror 12 having the independent and complete micro graphic-text structure 13 is able to display a complete pattern with depth of field. Due to that the duty ratio of the micro graphic-text area at the central position of the substrate 11 is larger than that of the micro graphic-text area at the edge position of the substrate 11, so that the reflecting curved mirror 12 displays as the three-dimensional pattern with depth of field after sampling and synthesizing with the micro graphic-text structure 13 having the coupling effect with it, and the three-dimensional pattern at least partially suspends on the side, away from the substrate 11, of the reflecting curved mirror 12, so that an optical effect with change of depth of field which shocks human eyes 20 is achieved; and the minimum unit radian of each reflecting curved mirror 12 having the micro graphic-text structure 13 corresponds to the projection angle, so that only the side surface of the three-dimensional pattern is able to be seen at the angle on the side, away from the substrate 11, of the reflecting curved mirror 12. The anti-counterfeiting element 10 of the disclosure combines an advantage that the reflecting curved mirror 12 and the micro graphic-text structure 13 are arranged on the same side of the substrate 11, the unique duty ratio of the micro graphic-text structure 13 is designed, the three-dimensional pattern with depth of field is formed, and a recognition difficulty of human eyes 20 is decreased.

It is to be noted that all the plurality of reflecting curved mirrors 12 having the independent micro graphic-text structure 13 are able to form one micro graphic-text area, in an embodiment of the disclosure, one micro graphic-text area includes one group of reflecting curved mirrors 12 having the micro graphic-text structure 13 or two groups of reflecting curved mirrors 12 having the micro graphic-text structure 13. It is also to be noted that the disclosure displays the three-dimensional pattern suspending above the substrate 11, the three-dimensional pattern displayed by at least one group of reflecting curved mirrors 12 having the micro graphic-text structure 13 are displayed vertical to the surface of the substrate 11, and the three-dimensional pattern displayed in the disclosure is not parallel to the surface of the substrate 11, for distinguishing the display effect of the related art.

As shown in FIG. 1, a direction vertical to the surface of substrate 11 is a Z-axis direction, and duty ratios of the plurality of micro graphic-text areas are gradually decreased from the central position to the edge position of the substrate 11 in an X-axis direction.

Specifically, the micro graphic-text structure 13 is a micro graphic-text groove, and at least part of the micro graphic-text groove in each reflecting curved mirror 12 penetrates through a top surface and a bottom surface of the reflecting curved mirror 12, and densities of micro graphic-text grooves in the plurality of reflecting curved mirrors 12 are gradually decreased from the central position to the edge position of the substrate 11. Three-dimensional patterns projected by the micro graphic-text areas with different duty ratios are different.

It is to be noted that a three-dimensional image animation of one object is able to be decomposed into multiple frames of images, and the multiple frames of images are rearranged according to periodic parameter design of the reflecting curved mirror 12, for accurately controlling real side pictures of a three-dimensional object seen by left and right eyes. In a process of rearranging the multiple frames of images, they are able to be arranged from left to right or from right to left, both of which are able to produce binocular parallax. When graphic-texts are arranged from right to left, an actual image seen by the right eye is on the left side of the image seen by the left eye, when the human brain synthesizes the image, an actual convergence position of the left and right images is above an actual position, then the human eyes 20 are able to see a “floating” image, causing an illusion of image protrusion to the human brain, and vice versa, causing an illusion of image sinking to the human brain. The illusion forms an effect of depth of field, and a spatial distance between left and right frames of images entering the human eyes 20 determines a size of the depth of field. That is, in the disclosure, a three-dimensional object is decomposed into multiple frames of three-dimensional patterns from different observing angles, a group of reflecting curved mirrors 12 having the micro graphic-text structure 13 is able to display a frame of three-dimensional pattern, and the frame of three-dimensional pattern is scattered by a computer program and then set in the reflecting curved mirror 12 in a form of the micro graphic-text structure 13.

In addition, the reflecting curved mirror 12 samples the micro graphic-text structure 13, finally, a sampled synthesized image is formed, and the sampled synthesized image is a macroscopic synthesized image which is able to be directly observed by human eyes 20. In an embodiment, the plurality of reflecting curved mirrors 12 are all hemispherical, and the plurality of reflecting curved mirrors 12 are all convex mirrors or concave mirrors, each reflecting curved mirror 12 is taken as a sub-area, and the micro graphic-text structure 13 sampled by the reflecting curved mirror 12 is arranged in each sub-area. In an embodiment, a periodic micro graphic-text structure 13 is adopted, a density of the micro graphic-text structure 13 in the sub-area depends on a period size of the micro graphic-text structure 13, and after an adoption of the periodic reflecting curved mirror 12, the greater a floating or sinking trend, the greater a trend of the depth of field of the displayed image. In an embodiment, two design drawings are arranged in two different periods, two three-dimensional patterns with different depths of field are obtained after sampling, and therefore, different depth of field effects formed by the periodic micro graphic-text structure 13 are non-continuous. When a nonperiodic micro graphic-text structure 13 is adopted, the micro graphic-text structure 13 in each sub-area does not have a fixed period, and in the disclosure, “duty ratio” is adopted for representing a density of the micro graphic-text groove. The greater the duty ratio of the micro graphic-text groove distributed in the reflecting curved mirror 12, the greater the density of the micro graphic-text groove, which is analogous to a case that a period of the reflecting curved mirror 12 is close to that of the micro graphic-text structure 13; on the contrary, the smaller the duty ratio of the micro graphic-text groove, the smaller the density of the micro graphic-text groove, and the sparser an arrangement of the micro graphic-text groove, which is analogous to a case that the period of the reflecting curved mirror 12 is far away from that of the micro graphic-text structure 13. For example, when the floating three-dimensional pattern is displayed, the greater the period of the micro graphic-text structure 13, the greater the depth of field.

As shown in FIG. 1, when a duty ratio of a micro graphic-text area is a maximum value, ae projection area of the three-dimensional pattern displayed by the micro graphic-text area on the substrate 11 is a minimum, and the three-dimensional pattern is vertically displayed on the side, away from the substrate 11, of the reflecting curved mirror 12. Referring to FIG. 1, the duty ratio of the micro graphic-text groove in the micro graphic-text area at the central position of the substrate 11 is a maximum, in such a case, the human eyes 20 observe on the side, away from the substrate 11, of the reflecting curved mirror 12 and at an angle corresponding to the micro graphic-text area, and a schematic diagram of a top surface of a three-dimensional pattern vertically arranged on the surface of the substrate 11 is able to be seen; and the three-dimensional pattern is arranged vertical to the substrate 11, and therefore, a projection area of the three-dimensional pattern on the substrate 11 is a minimum. As shown in FIG. 1, the side surface of the three-dimensional pattern is shown in the figure, and a state of the three-dimensional pattern displayed in the figure is able to be any angle of the three-dimensional pattern.

As shown in FIG. 1, a side view of a three-dimensional pattern vertically arranged is able to be seen under most angles of the side, having the reflecting curved mirror 12, of the substrate 11, and a three-dimensional pattern inclining towards the surface of the substrate is able to be seen only under a small part of angles of the side, having the reflecting curved mirror 12, of the substrate 11.

In FIG. 1, three-dimensional patterns seen under three angles of the side, having the reflecting curved mirror 12, of the substrate 11 are drawn, it can be seen from the figure that the three-dimensional patterns are vertically arranged above the substrate 11, a three-dimensional pattern in the middle is vertical to the surface of the substrate 11, and three-dimensional patterns on two sides incline outwards relative to the three-dimensional pattern in the middle. The displayed three-dimensional pattern is a front side and back side of the object, referring to the three-dimensional pattern “5” shown in FIG. 1, the three-dimensional pattern displayed on the leftmost side is the front side, the three-dimensional pattern displayed on the rightmost side is the back side, and “display” refers to directions shown in FIG. 1 and FIG. 2, but not to the direction observed by the human eyes 20. The displayed three-dimensional pattern is the front side and back side of the object, that is, when the anti-counterfeiting element 10 is tilted left and right, the front and side of an object can be seen.

Specifically, at least part of the plurality of reflecting curved mirrors 12 is arranged in a periodic array, that is, the plurality of reflecting curved mirrors 12 are arranged in a periodic array, or only part of the plurality of reflecting curved mirrors 12 are arranged in a periodic array, and the micro graphic-text structure 13 in each reflecting curved mirror 12 is arranged in a periodic array or a nonperiodic array. Or, the plurality of reflecting curved mirrors 12 are in a nonperiodic array or a random array.

It is to be notated that to produce any animation effect, a general design method of the micro graphic-text structure 13 is required, which includes the following three steps.

S1, macroscopic magnified images F (θi, φj) seen at each observation angle are determined, θ and φ are respectively an inclination angle of a sample rotating along a y axis and an inclination angle of the sample rotating along an x axis, i and j are respectively serial numbers of animation frames of the sample rotating along the y axis and the x axis, with the ranges of i and j set as 1, 2, 3 . . . . M. That is, M frames are respectively taken in the x and y directions, and the total number of frames is M*M frames.

S2, each macroscopic magnified image F (θi, φj) is pixelated according to an actual size of a macroscopic image and a size of a microsampling tool, and each pixel corresponds to one microsampling tool; for example, if the macroscopic image is a square with a side length L and a spacing of the microsampling tool p, then a number of the microsampling tools included in the length of L is N=L/p. The macroscopic magnified image F (θi, φj) is scaled to N*N pixels to achieve that each pixel corresponds to one microsampling tool.

S3, each pixel is projected to the corresponding micro graphic-text area of the microsampling tool according to the observation angle. The design of the micro graphic-text array is completed after traversing all macroscopic images and all microsampling tools.

The plurality of reflecting curved mirrors are arranged in a periodic array or a nonperiodic array. Since a function of the reflecting curved mirror 12 is to reflect light into the human eyes 20, its morphology is smooth and continuous, in an embodiment, it is a convex mirror and a concave mirror.

It is to be noted that a degree of overlap without an interval between the micro graphic-text structure 13 and the reflecting curved mirror 12, namely, a positional depth of the micro graphic-text structure 13 distributed on the reflecting curved mirror 12, will change a gray level of a dark image. However, in practical application, the micro graphic-text structure 13 overlaps the surface of the reflecting curved mirror 12 as much as possible without an interval, in an embodiment, a depth of the micro graphic-text structure 13 is smaller than 1 micron, so that after the surface of the reflecting curved mirror 12 is covered with a metal coating, a definition of the macroscopic synthesized image is better.

In an embodiment, an arrangement period of the plurality of reflecting curved mirrors 12 is 5 microns to 200 microns; more specifically, the arrangement period of the plurality of reflecting curved mirrors 12 is 25 microns. In an embodiment, a width of the micro graphic-text groove is 0.2 micron to 100 microns; more specifically, the width of the micro graphic-text groove is 2 microns.

Through the above technical solution, in the disclosure, by designing the duty ratio of the micro graphic-text structure 13 in the reflecting curved mirror 12, which has a rule of gradually reducing from center to edge, the three-dimensional pattern with depth of field is achieved. The three-dimensional pattern is more three-dimensional, more intuitive, and more representative in 3d.

Specifically, the anti-counterfeiting element 10 further includes a reflecting layer 14, the reflecting layer 14 is arranged on a side surface, away from the substrate 11, of the reflecting curved mirror 12. The reflecting layer 14 includes one or more of the following: a single-layer metal coating, a multi-layer metal coating, a coating formed by an absorption layer, a low-refractive-index dielectric layer and a reflective film layer, a high-refractive-index dielectric layer coating, a multi-dielectric-layer coating formed by a first high-refractive-index dielectric layer, the low-refractive-index dielectric layer and a second high-refractive-index dielectric layer stacked in sequence, and a coating formed by the absorption layer, a high-refractive-index dielectric layer and the reflective film layer stacked in sequence.

In the embodiment of the disclosure, the micro graphic-text structure 13 is the micro graphic-text groove, but in another embodiment not shown in the disclosure, the micro graphic-text structure 13 is a plane or a protrusion. Of course, the micro graphic-text structure 13 is also a structure having a microstructure with small-size, and the micro graphic-text structure 13 and the reflecting curved mirror 12 are different in light reflecting intensity.

Specifically, the anti-counterfeiting element 10 further includes the microstructure with small-size, the microstructure with small-size is arranged in the micro graphic-text groove, and the microstructure includes one of a one-dimensional submicron structure, a two-dimensional submicron structure and an interference structural color.

Of course, in an embodiment of the disclosure, the anti-counterfeiting element 10 further includes a first color functional layer and a second color functional layer, the first color functional layer is arranged in the micro graphic-text groove, the second color functional layer is arranged on the surface of the reflecting curved mirror 12, and the first color functional layer includes one of a single-layer coating, a multi-layer coating, an ink, a pigment and a dye; and the second color functional layer includes one of the single-layer coating, the multi-layer coating, the ink, the pigment and the dye. The first color functional layer and the second color functional layer are the same or different, when the micro graphic-text structure 13 of the disclosure is a plane, the first color functional layer and the second color functional layer are different.

The anti-counterfeiting element 10 of the disclosure will be described in combination with specific embodiments and drawings.

FIGS. 1-2 show a schematic diagram of a sectional view in which the anti-counterfeiting element 10 of the disclosure is vertical to the surface of the substrate 11. The anti-counterfeiting element 10 includes a substrate 11 and a plurality of reflecting curved mirrors 12 arranged on a side surface of the substrate 11, a part of the plurality of reflecting curved mirrors 12 are provided with independent micro graphic-text grooves correspondingly, for example, three reflecting curved mirrors 12 in the middle in FIG. 1, and a reflecting layer 14 is further arranged on the surface of the reflecting curved mirror 12. A plurality of groups of reflecting curved mirrors 12 having the micro graphic-text groove are divided into three micro graphic-text areas from the central position to the edge position of the substrate 11, the three micro graphic-text areas include a first micro graphic-text area 15, a second micro graphic-text area 16 and a third micro graphic-text area 17 in sequence from the central position to the edge position of the substrate 11, and a duty ratio is gradually decreased from the first micro graphic-text area 15 to the third micro graphic-text area 17. That is, a duty ratio of the micro graphic-text groove of the first micro graphic-text area 15 is greater than that of the micro graphic-text groove of the second micro graphic-text area 16, and a duty ratio of the micro graphic-text groove of the second micro graphic-text area 16 is greater than that of the micro graphic-text groove of the third micro graphic-text area 17. After the reflecting curved mirror 12 samples and synthesizes with the micro graphic-text groove having a coupling effect with it, a feature that the duty ratio of the micro graphic-text groove gradually increases is displayed in that the depth of field of the three-dimensional pattern gradually increases. It is to be notated that the three-dimensional pattern at least partially suspends above the surface of the substrate 11, in an embodiment, a lowermost end of the three-dimensional pattern is level with the surface of the substrate 11.

In FIG. 2, the first micro graphic-text area 15 includes a group of reflecting curved mirrors 12 having the micro graphic-text structure 13, and the first micro graphic-text area 15 presents a side view when the three-dimensional pattern is vertical under a corresponding angle. The second micro graphic-text area 16 at least includes two groups of reflecting curved mirrors 12 having the micro graphic-text structure 13, duty ratios of the two groups of reflecting curved mirrors 12 having the micro graphic-text structure 13 are the same, the two groups of reflecting curved mirrors 12 having the micro graphic-text structure 13 are arranged in a manner of clamping the first micro graphic-text area 15, and a projection area of the three-dimensional pattern projected by the second micro graphic-text area 16 on the substrate 11 is greater than that of the three-dimensional pattern projected by the first micro graphic-text area 15 on the substrate 11. The third micro graphic-text area 17 at least includes two groups of reflecting curved mirrors 12 having the micro graphic-text structure 13, and duty ratios of the two groups of reflecting curved mirrors 12 having the micro graphic-text structure 13 are the same.

Specifically, the micro graphic-text structures 13 are arranged in a periodic array to be displayed as three-dimensional patterns with different depths of field; or the micro graphic-text structures 13 are arranged in a nonperiodic array to be displayed as three-dimensional patterns with continuous depth of field.

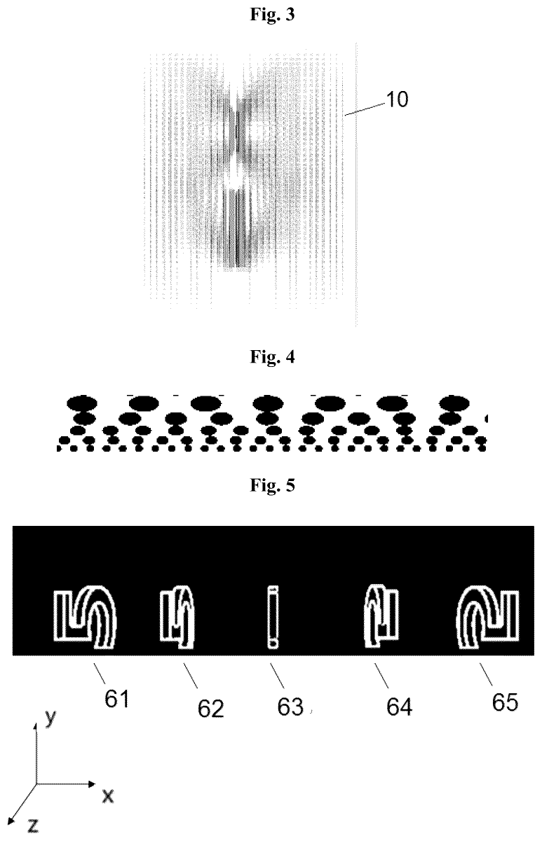

FIG. 3 is a top view of an anti-counterfeiting element 10 in the embodiment, when a nonperiodic micro graphic-text groove is adopted in each reflecting curved mirror 12, the micro graphic-text groove in each micro graphic-text area does not have a fixed period, and in the disclosure, “duty ratio” is adopted for representing the density of the micro graphic-text groove. The greater the duty ratio of the micro graphic-text groove distributed in the reflecting curved mirror 12, the denser the micro graphic-text; on the contrary, the smaller the duty ratio, the sparser the micro graphic-text. FIG. 3 shows a top view of a micro graphic-text groove with continuous depth of field. It can be seen from the figure, when the duty ratio of the micro graphic-text groove is the maximum, a view when the projection area is the minimum is shown. The maximum duty ratio of the micro graphic-text groove means that a difference between multiple frames of macroscopic images is not obvious, namely, an actual image is appeared when the object is observed from the top view.

FIG. 4 shows a design diagram of periodic micro graphic-text grooves with different depths of field of the disclosure. The periodic micro graphic-text groove is adopted, and the density of the micro graphic-text groove in the micro graphic-text area depends on the period size of the micro graphic-text groove. As shown in FIG. 4, the micro graphic-text groove has 5 micro graphic-text areas with different periods, each row represents a periodic arrangement, and from the topmost row to the bottommost row, the period of the micro graphic-text area gradually decreases. In an embodiment, a design of floating effect is adopted, from the topmost row to the bottommost row of the micro graphic-text area, the depth of field of the three-dimensional image is gradually decreased.

Specifically, different depths of field effects formed by the periodic micro graphic-text grooves of different micro graphic-text areas are non-continuous. The micro graphic-text grooves in different micro graphic-text areas are different, so that different micro graphic-text areas form patterns with different three-dimensional effects, and the patterns have different depths of field. In an embodiment, an image-text with morphology correlation is selected, then the formed three-dimensional pattern has correlation, so that a certain meaning is able to be reflected in product application, and a certain artistic value is also achieved.

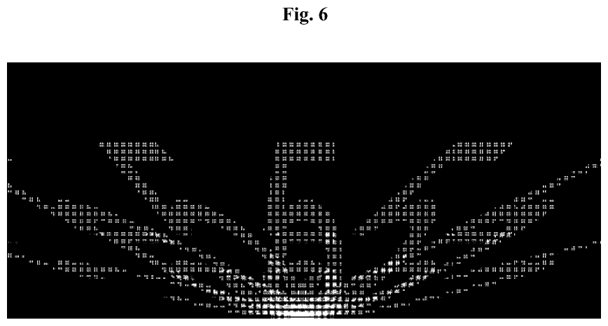

As shown in FIGS. 5-6, the displayed three-dimensional pattern has two models in design, including an original image of the object and a projection image of the object. The original image and the projection image of the object are modeled respectively, or the object is transformed into a three-dimensional space, and the micro graphic-text structure 13 after the use of reflecting curved mirror 12 is able to be obtained.

FIG. 5 is a design model of a three-dimensional pattern of the disclosure. Taking a three-dimensional object of text “5” as an example, “What You See Is What You Get” is a common model for three-dimensional object modeling, in the model, the three-dimensional object has multiple frames of images at different tilt angles, and each frame of image has a certain rotation and scaling relative to the original object before tilt. For multiple frames of images 61, 62, 63, 64 and 65 under different viewing angles, the object rotates and changes along a certain direction as the viewing angle changes.

In an embodiment, a spatial transformation matrix is adopted to model objects from different viewing angles. The matrix is described as:

| 1 | 0 | 0 |
|---|---|---|
| 0 | cos(α) | sin(α) |
| 0 | −sin(α) | cos(α) |

The Three-dimensional matrix describes the rotation and scaling relations of objects in three-dimensional space, and solves the transformation model of objects in three-dimensional space. With the model, multiple frames of images from different viewing angles are able to be obtained, such as 61-65 in FIG. 5. The reflecting curved mirror 12 is adopted for sampling multiple frames of images under different angles, and then an arrangement structure similar to the micro graphic-text groove in FIG. 3 is able to be obtained. That is, in design, 5 frames of images in FIG. 5 correspond to 5 reflecting curved mirrors 12 one by one, and one frame of image corresponding to each reflecting curved mirror 12 is the projection effect of combination of the two after the image is scattered and arranged in the reflecting curved mirror 12 in the form of the micro graphic-text groove.

FIG. 6 is another design model of a three-dimensional pattern of the disclosure. The displayed three-dimensional pattern has two models in design, also including a projection model of the object except an original object in FIG. 5.

The projection model is also able to be obtained by using a space transformation matrix, compared with the original object model, the scaling parameters in the space transformation matrix need to be designed to obtain the three-dimensional pattern during projection. The difference between the projection model and the original object model in FIG. 5 is that when the viewing angle approaches 0° and 180°, the image area of the projection model is larger than that of the original object model.

It is to be noted that during observation in a top view, there is little difference between multiple frames of images generated by the two models.

Obviously, the above-described embodiments are only some, but not all, embodiments of the disclosure. All other embodiments obtained by those of ordinary skill in the art based on the embodiments of the disclosure without creative efforts shall fall within the protection scope of the disclosure.

It is to be noted that terms used herein are for the purpose of describing specific implementation modes only and are not intended to be limiting of exemplary implementation modes according to the disclosure. Unless otherwise directed by the context, singular forms of terms used herein are intended to include plural forms. Besides, it will be also appreciated that when terms “contain” and/or “include” are used in the description, it is indicated that features, steps, operations, devices, assemblies and/or a combination thereof exist.

It is to be noted that the terms “first,” “second,” and the like in the specification, the claims and the drawings of the disclosure are used for distinguishing between similar objects and not necessarily for describing a particular sequence or sequential order. It will be appreciated that such data may be interchangeable where appropriate, so that the implementation modes of the disclosure described herein can be implemented in a sequence except for those illustrated or described herein.

The foregoing is merely preferred embodiments of the disclosure and is not intended to limit the disclosure, and various modifications and variations of the disclosure may be available for those skilled in the art. Any modifications, equivalent replacements, improvements and the like made within the spirit and principle of the disclosure shall fall within the scope of protection of the disclosure.

1. An anti-counterfeiting element, comprising:
a substrate;
a reflecting curved mirror, a plurality of reflecting curved mirrors are provided, and the plurality of reflecting curved mirrors are arranged on a side surface of the substrate in an array;
a micro graphic-text structure, at least part of the plurality of reflecting curved mirrors is provided with the independent micro graphic-text structure, the micro graphic-text structure is divided into a plurality of micro graphic-text areas from a central position to an edge position of the substrate, using a period of the reflecting curved mirror as a unit, and a duty ratio of a micro graphic-text area at the central position of the substrate is larger than a duty ratio of a micro graphic-text area at the edge position of the substrate;
the reflecting curved mirror displays as a three-dimensional pattern with depth of field after sampling and synthesizing with the micro graphic-text structure having a coupling effect with it, and the three-dimensional pattern at least partially suspends on a side, away from the substrate, of the reflecting curved mirror; and a minimum unit radian of each reflecting curved mirror having the micro graphic-text structure corresponds to a projection angle, so that only a side surface of the three-dimensional pattern is able to be seen at an angle on the side, away from the substrate, of the reflecting curved mirror.

2. The anti-counterfeiting element according to claim 1, wherein
the micro graphic-text structure is arranged in a periodic array to be displayed as three-dimensional patterns with different depths of field; or
the micro graphic-text structure is arranged in a nonperiodic array to be displayed as three-dimensional patterns with continuous depth of field.

3. The anti-counterfeiting element according to claim 1, wherein duty ratios of the plurality of micro graphic-text areas are gradually decreased from the central position to the edge position of the substrate.

4. The anti-counterfeiting element according to claim 1, wherein the micro graphic-text structure is a micro graphic-text groove, and at least part of the micro graphic-text groove in each reflecting curved mirror penetrates through a top surface and a bottom surface of the reflecting curved mirror.

5. The anti-counterfeiting element according to claim 4, wherein densities of micro graphic-text grooves in the plurality of reflecting curved mirrors are gradually decreased from the central position to the edge position of the substrate.

6. The anti-counterfeiting element according to claim 1, wherein when a duty ratio of a micro-image-text area is a maximum value, a projection area of the three-dimensional pattern displayed by the micro graphic-text area on the substrate is a minimum, and the three-dimensional pattern is vertically displayed on the side, away from the substrate, of the reflecting curved mirror.

7. The anti-counterfeiting element according to claim 1, wherein a side view of the three-dimensional pattern vertically arranged is able to be seen when observed from part of angles of a side, having the reflecting curved mirror, of the substrate.

8. The anti-counterfeiting element according to claim 1, wherein the plurality of micro graphic-text areas comprise a first micro graphic-text area, a second micro graphic-text area and a third micro graphic-text area in sequence from the central position to the edge position of the substrate, and a duty ratio is gradually decreased from the first micro graphic-text area to the third micro graphic-text area.

9. The anti-counterfeiting element according to claim 8, wherein the first micro graphic-text area at least comprises a group of reflecting curved mirrors having the micro graphic-text structure, and the first micro graphic-text area presents a side view when the three-dimensional pattern is vertical under a corresponding angle.

10. The anti-counterfeiting element according to claim 8, wherein the second micro graphic-text area at least comprises two groups of reflecting curved mirrors having the micro graphic-text structure, duty ratios of the two groups of reflecting curved mirrors having the micro graphic-text structure are the same, and the two groups of reflecting curved mirrors having the micro graphic-text structure are arranged in a manner of clamping the first micro graphic-text area, and a projection area of the three-dimensional pattern displayed by the second micro graphic-text area on the substrate is greater than a projection area of the three-dimensional pattern displayed by the first micro graphic-text area on the substrate.

11. The anti-counterfeiting element according to claim 8, wherein the third micro graphic-text area at least comprises two groups of reflecting curved mirrors having the micro graphic-text structure, and duty ratios of the two groups of reflecting curved mirrors having the micro graphic-text structure are the same.

12. The anti-counterfeiting element according to claim 1, wherein the plurality of reflecting curved mirror are all convex mirrors or concave mirrors.

13. The anti-counterfeiting element according to claim 1, wherein at least part of the plurality of reflecting curved mirrors is arranged in a periodic array.

14. The anti-counterfeiting element according to claim 1, wherein the anti-counterfeiting element further comprises a reflecting layer, the reflecting layer is arranged on a side surface, away from the substrate, of the reflecting curved mirror.

15. The anti-counterfeiting element according to claim 14, wherein the reflecting layer comprises one or more of the following:
a single-layer metal coating;
a multi-layer metal coating;
a coating formed by an absorption layer, a low-refractive-index dielectric layer and a reflective film layer;
a high-refractive-index dielectric layer coating;
a multi-dielectric-layer coating formed by a first high-refractive-index dielectric layer, the low-refractive-index dielectric layer and a second high-refractive-index dielectric layer stacked in sequence;
a coating formed by the absorption layer, a high-refractive-index dielectric layer and the reflective film layer stacked in sequence.

16. The anti-counterfeiting element according to claim 4, wherein the anti-counterfeiting element further comprises a microstructure, the microstructure is arranged in the micro graphic-text groove, and the microstructure comprises one of a one-dimensional submicron structure, a two-dimensional submicron structure and an interference structural color.

17. The anti-counterfeiting element according to claim 4, wherein the anti-counterfeiting element further comprises a first color functional layer and a second color functional layer, the first color functional layer is arranged in the micro graphic-text groove, the second color functional layer is arranged on a surface of the reflecting curved mirror,
the first color functional layer comprises one of a single-layer coating, a multi-layer coating, an ink, a pigment and a dye; and/or
the second color functional layer comprises one of the single-layer coating, the multi-layer coating, the ink, the pigment and the dye.
